(19) United States
(12) Patent Application Publication
(10) Pub. No.: US 2012/0197726 A1
(43) Pub. Date: Aug. 2, 2012

(54) METHOD AND SYSTEM FOR SUGGESTING SERVICES TO A USER

(75) Inventors: Mukesh Aggarwal, Fremont, CA (US); Nilendu Misra, Mountain View, CA (US)

(73) Assignee: INTUIT INC., Mountain View, CA (US)

(21) Appl. No.: 13/016,724

(22) Filed: Jan. 28, 2011

(51) Int. Cl. G06Q 30/00

(52) U.S. Cl. 705/14.64

(57) ABSTRACT

A method for presenting a vendor selection to a user of a mobile device, including receiving a notification that a first telephone call is initiated by the user of the mobile device to a telephone number for a vendor; while the first telephone call is active and prior to placing an order with the vendor: extracting a set of matching data for the vendor using the telephone number for the vendor, selecting at least one suggested vendor associated with an offer using a set of matching parameters and the set of matching data, generating a message comprising the vendor and the at least one suggested vendor with the offer; and presenting the message to the user of the mobile device, terminating, prior to placing the order, the first telephone call to the vendor, and initiating a second telephone call to the at least one suggested vendor based on the offer.

### BACKGROUND

Today's mobile devices, such as smart phones, allow users to browse the Internet from any location to obtain information on demand. As long as a user is in an area with the proper telecommunication network and subscribes to a data plan, the user is provided with access to the Internet for web browsing to obtain information, such as phone numbers for service providers, map out a particular destination location, and obtain information relevant to the user's current or next activity.

Users often rely on coupons or promotions from vendors in order to receive the best price for goods or services. Often, a user must manually search for the best deal for goods or services either on the Internet or by contacting each vendor individually.

### SUMMARY

In general, in one aspect, the invention relates to a method for presenting a vendor selection to a user of a mobile device. The method comprises: receiving a notification that a first telephone call is initiated by the user of the mobile device to a telephone number for a first vendor; while the first telephone call is active and prior to placing an order with the first vendor: extracting, using a computer processor, a plurality of matching data for the first vendor using the telephone number for the first vendor, selecting, using the computer processor, at least one suggested vendor using a plurality of matching parameters and the plurality of matching data, wherein each of the at least one suggested vendor is associated with an offer, generating a message comprising the first vendor and the at least one suggested vendor with the offer; and presenting the message to the user of the mobile device, terminating, prior to placing the order, the first telephone call to the first vendor, and initiating a second telephone call to the at least one suggested vendor based on the offer.

In general, in one aspect, the invention relates to a computer readable storage medium comprising computer readable code that, when executed by a processor, is configured to perform a method. The method comprises: receiving a notification that a first telephone call is initiated by a user of a mobile device to a telephone number for a first vendor; while the first telephone call is active and prior to placing an order with the first vendor: extracting a plurality of matching data for the first vendor using the telephone number for the first vendor, selecting at least one suggested vendor using a plurality of matching parameters and the plurality of matching data, wherein each of the at least one suggested vendor is associated with an offer, generating a message comprising the first vendor and the at least one suggested vendor with the offer; and presenting the message to the user of the mobile device, terminating, prior to placing the order, the first telephone call to the first vendor; and initiating a second telephone call to the at least one suggested vendor based on the offer.

In general, in one aspect, the invention relates to a system for presenting a vendor selection to a user. The system comprises: vendor account data store located on a persistent storage device and comprising a plurality of vendors and a plurality of matching data; a mobile device configured to: initiate a first telephone call to a first vendor of the plurality of vendors; receive and present a message to the user of the mobile device; terminate, prior to placing an order, the first telephone call to the first vendor; and initiate a second telephone call to at least one suggested vendor based on an offer; and a matching module executable by a computer processor and configured to: receive a notification that the first telephone call is initiated by the user of the mobile device to a telephone number for the first vendor; while the first telephone call is active and prior to placing an order with the first vendor: extract the plurality of matching data for the first vendor using the telephone number for the first vendor, select at least one suggested vendor from the plurality of vendors using a plurality of matching parameters and the plurality of matching data, wherein each of the at least one suggested vendor is associated with the offer, and generate the message comprising the first vendor and the at least one suggested vendor with the offer.

In general, in one aspect, the invention relates to a method for presenting a vendor selection to a user. The method comprises: determining, using a computer processor, that a first telephone call to a first vendor has been initiated on a mobile device, wherein a user of the mobile device has initiated the first telephone call using a telephone number for the first vendor; while the first telephone call is active and prior to placing an order with the first vendor, sending a request for suggested vendors to a matching system, wherein the matching system is configured to: extract a plurality of matching data for the first vendor using the telephone number for the first vendor, selecting the at least one suggested vendor using a plurality of matching parameters and the plurality of matching data, wherein each of the at least one suggested vendor is associated with an offer, and generating a message comprising the first vendor and the at least one suggested vendor with the offer, and presenting the message to the user of the mobile device; terminating, prior to placing the order, the first telephone call to the first vendor; and initiating a second telephone call to the at least one suggested vendor based on the offer.

Other aspects of the invention will be apparent from the following description and the appended claims.

### BRIEF DESCRIPTION OF DRAWINGS

FIG. 1 shows a system in accordance with one or more embodiments of the invention.

FIGS. 2-4 show flowcharts in accordance with one or more embodiments of the invention.

FIG. 5 shows an example flow diagram in accordance with one or more embodiments of the invention.

FIG. 6 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for presenting a vendor selection to a user of a mobile device. More specifically, embodiments of the invention are directed to identifying that a call is initiated to a first vendor, extracting matching data for the first vendor, selecting a suggested vendor using the matching data, and presenting the suggested vendor to the user. Effectively, embodiments of the invention allow the user of a mobile device, while making a call to one vendor, to receive one or more offers from known competitors in hopes that the user decides to terminate the call and then call one of the competitors based on the offer. Accordingly, the competitor gets new business (while taking business away from the original vendor) and the user of the mobile device gets a better deal.

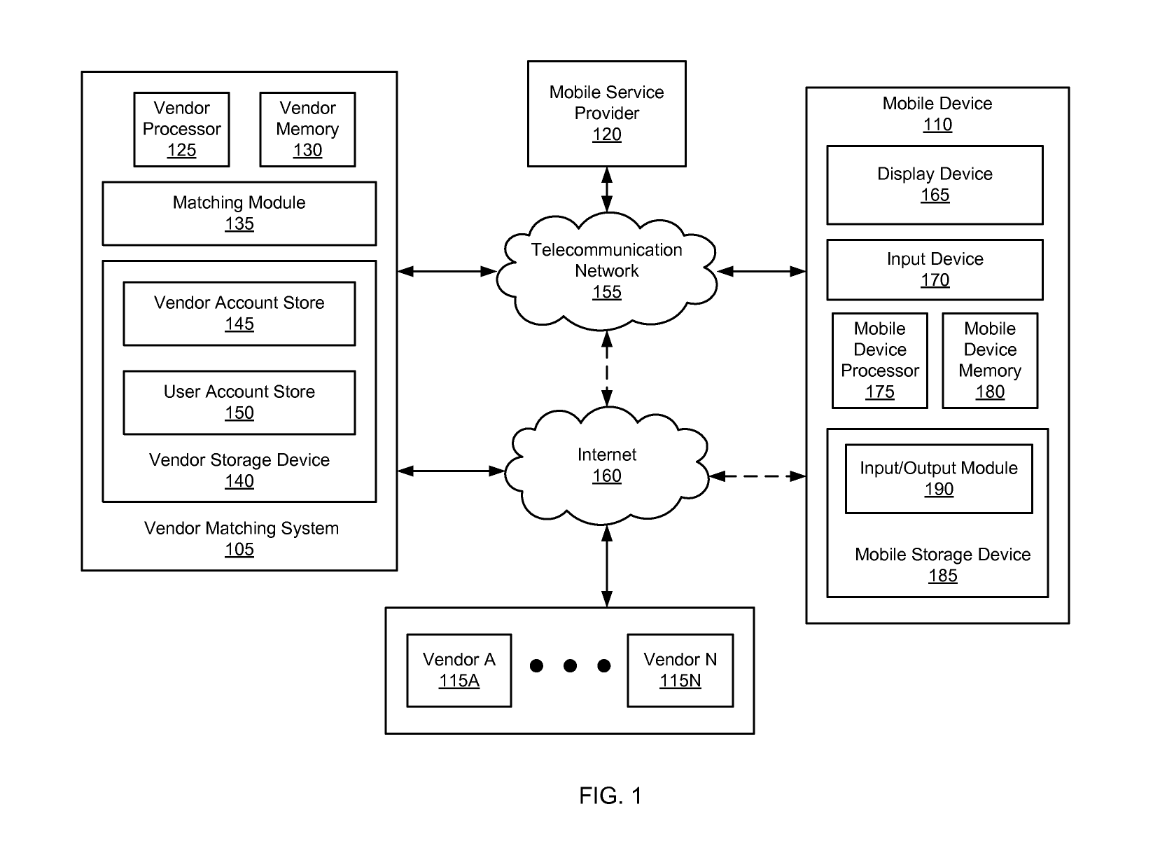

FIG. 1 shows a system in accordance with one or more embodiments of the invention. Specifically, FIG. 1 includes a vendor matching system (105), a mobile device (110), a mobile service provider (120), and a set of vendors (e.g., Vendor A (115A)-Vendor N (115N)). These components are configured to connect to each other over a telecommunication network (155) and/or the Internet (160). Those skilled in the art will appreciate that the Internet (160) may, alternatively, be any type of network (e.g., a local area network (LAN), a wide area network (WAN), or any other type of network). Further, those skilled in the art will appreciate that the telecommunication network (155) may be a public switched telephone network (PSTN), or any other suitable network for exchanging messages between the vendor matching system (105) and the mobile device (110).

According to one or more embodiments of the invention, the vendor matching system (105) is configured to identify suggested vendors for a user. According to one or more embodiments of the invention, the vendor matching system (105) includes a vendor processor (125), a vendor memory (130), a matching module (135), and a vendor storage device (140). Further, the vendor storage device, according to one or more embodiments of the invention, includes a vendor account store (145) and a user account store (150).

According to one or more embodiments of the invention, the vendor processor (125) is a computer processor, such as am integrated circuit, central processing unit, or any kind of hardware processor. Further, the vendor memory (130) may be random access memory (RAM), cache memory, flash memory, or any other memory capable of storing data. According to one or more embodiments of the invention, the vendor storage device (140) is a persistent storage device, such as a hard disk, an optical drive such as a compact disk drive or digital video disk (DVD) drive, a flash memory stick, etc.

According to one or more embodiments of the invention, the vendor account store (145) is configured as a data structure to store vendor data. For example, according to one or more embodiments of the invention, the vendor data may include data such as services provided by the vendor, advertisements for the vendor, enhanced offers for the vendor, or any other vendor data to be used by the vendor matching system (105). Further, according to one or more embodiments of the invention, the vendor account store (145) may also store identifying information for a vendor, such as a telephone number for the vendor, a type of service provided by the vendor, or other identifying vendor information. For purposes of this description, the term “service” is used to describe any good, product, service, or other commodity which may be purchased from a vendor in a transaction. Moreover, the vendor account store (145) may also be configured to store matching data (not shown) for the vendor. According to one or more embodiments of the invention, matching data for the vendor may include any vendor data used to determine whether a vendor should be identified (or matched) as a suggested vendor for a user. For example, according to one or more embodiments of the invention, the matching data may include the services provided by the vendor, a location for the vendor, data regarding enhanced offers provided by the vendor, or any other vendor data that the vendor matching system (105) may use to determine whether the vendor should be a suggested vendor for a user.

According to one or more embodiments of the invention, the user account store (150) is configured as a data structure to store user data. According to one or more embodiments of the invention, user data includes identifying data for a user, such as a telephone number or other data (e.g., Internet Protocol (IP) address, serial number, etc.) identifying a telephone or other mobile device from which the user may be calling. The user account store (150) may store other user account information, such as data stored on the mobile device, personal preferences, and/or personal matching parameters. According to one or more embodiments of the invention, personal matching parameters include, for example, preferred vendors chosen by the user, preferred locations chosen by the user, or any other personal preferences chosen by the user that could be used to generate a suggested vendor for the user.

According to one or more embodiments of the invention, the vendor matching system (105) includes a matching module (135). According to one or more embodiments, the matching module (135) is a module, such as computer executable code, which is configured to execute on computer hardware and generate suggested vendors for a user.

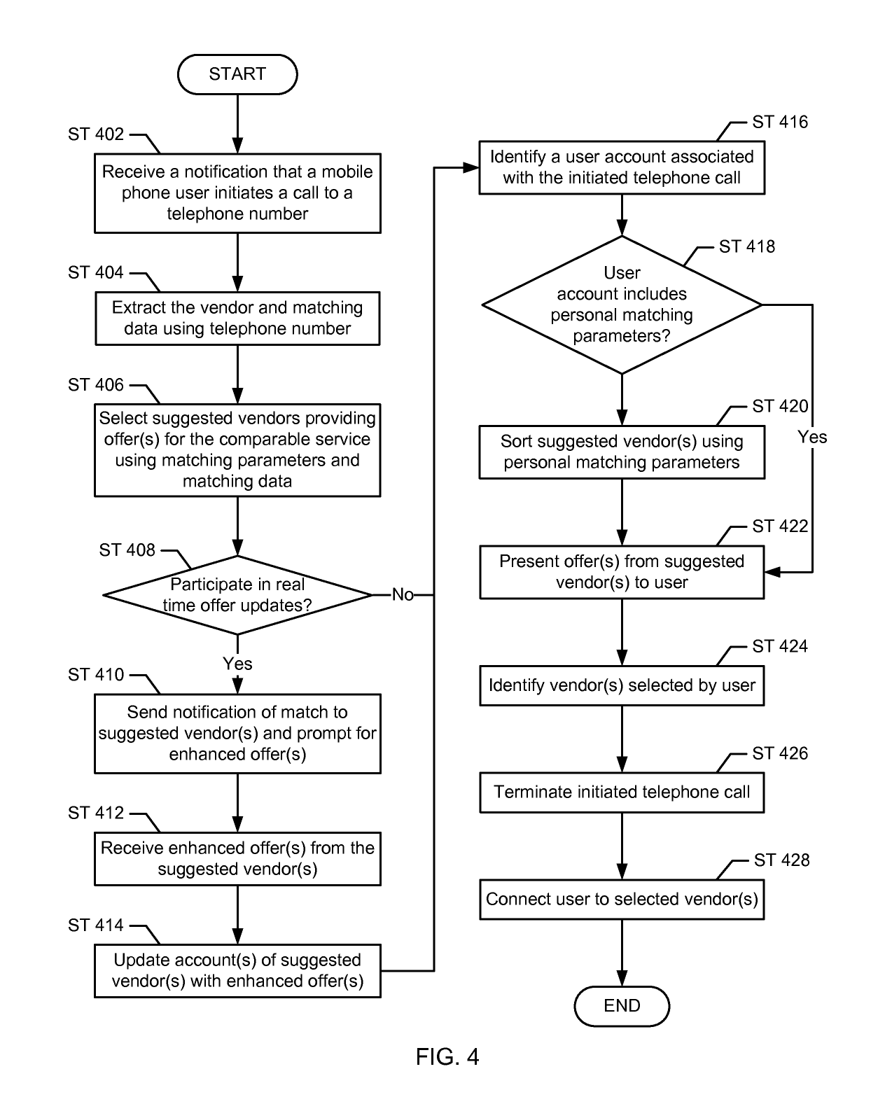

Further, according to one or more embodiments of the invention, the matching module (135) is configured to intercept a telephone call from the mobile device (110) prior to an order being placed by the user of the mobile device with the vendor. For example, the call may be intercepted prior to the connection of the caller with the vendor, while the caller is on hold waiting to place an order with the vendor, or in the middle of placing the order with the vendor but prior to completing the order. Although FIG. 1 shows the matching module (135) as located within the vendor matching system (105), according to one or more embodiments of the invention the matching module may alternatively, or additionally, be located within the mobile device (110). For example, according to one or more embodiments of the invention, the matching module (135) may be deployed in the form of a mobile application executing on the mobile device (110). The functionality of the matching module (135) is described in detail with respect to FIG. 4, below.

According to one or more embodiments of the invention, the vendor matching system (105) is configured to generate suggested vendors, in part, from data received from the mobile device (110). According to one or more embodiments of the invention, the mobile device (110) may be any mobile device, such as a Code Division Multiple Access (CDMA) device, a global system mobile (GSM) device, a 3G device, a 4G device, or any other mobile device or smart phone that includes functionality for making telephone calls and receiving either audio or graphical messages from the vendor matching system (105). The mobile device (110) may include, for example, a display device (165), an input device (170), a mobile device processor (175), a mobile device memory (180), and a mobile storage device (185). According to one or more embodiments of the invention, the mobile storage device (185) includes an input/output module (190).

The display device (165) of the mobile device (110) may be a display screen incorporating technology such as liquid crystal display (LCD), a light emitting diode (LED), organic light emitting diode (OLED), or any other suitable type of display screen (physical or virtual) capable of displaying the content of received graphical messages. In one or more embodiments of the invention, the input device (170) may be a virtual keyboard, a physical keyboard, or any other input/output device(s) or button(s) that allows a user to interactively operate the mobile device (110).

The mobile device processor (175) may be any tangible hardware processor(s) or microprocessor(s) for executing the functionalities of the mobile device (110). More specifically, the mobile device processor (175) is configured to execute software application(s) that provide functionalities such as browsing, text messaging, maintaining a contact list, making telephone calls, etc. Further, in embodiments of the invention where the matching module (135) is located within the mobile device (110), the mobile device processor (175) is configured to execute the matching module (135).

According to one or more embodiments of the invention, the mobile device memory (180) may be random access memory (RAM), cache memory, flash memory, etc. According to one or more embodiments of the invention, the mobile storage device (185) is a persistent storage device, such as a hard disk, an optical drive such as a compact disk drive or digital video disk (DVD) drive, a flash memory stick, a solid state drive, etc. Further, according to one or more embodiments of the invention, the input/output module (190) is a module, such as computer executable code, which is configured to send and receive signals from input and output devices for the mobile device (110), such as the input device (170), and the display device (165). Further, according to one or more embodiments of the invention, the input/output module (190) executes on computer hardware and is configured to generate an audio, textual, or visual message to present to the user.

As shown, the vendor matching system (105) and the mobile device (110) may be operatively connected to a mobile service provider (120). In one or more embodiments of the invention, the mobile service provider (120) may be configured to provide telecommunications services to the mobile device (110). Common examples of a mobile service provider include mobile phone carriers such as AT&T, Verizon, Sprint, T-Mobile, Vodafone, NTT Docomo, etc. Further, according to one or more embodiments of the invention, the mobile service provider (120) includes functionality to intercept telephone calls initiated by the mobile device (110), as well as provide a connected call between the mobile device (110) and one or more vendor(s) (e.g., Vendor A (115A)-Vendor N (115N)). Further, according to one or more embodiments of the invention, the mobile service provider (120) may provide a connection between the mobile device (110) and the vendor matching system (105).

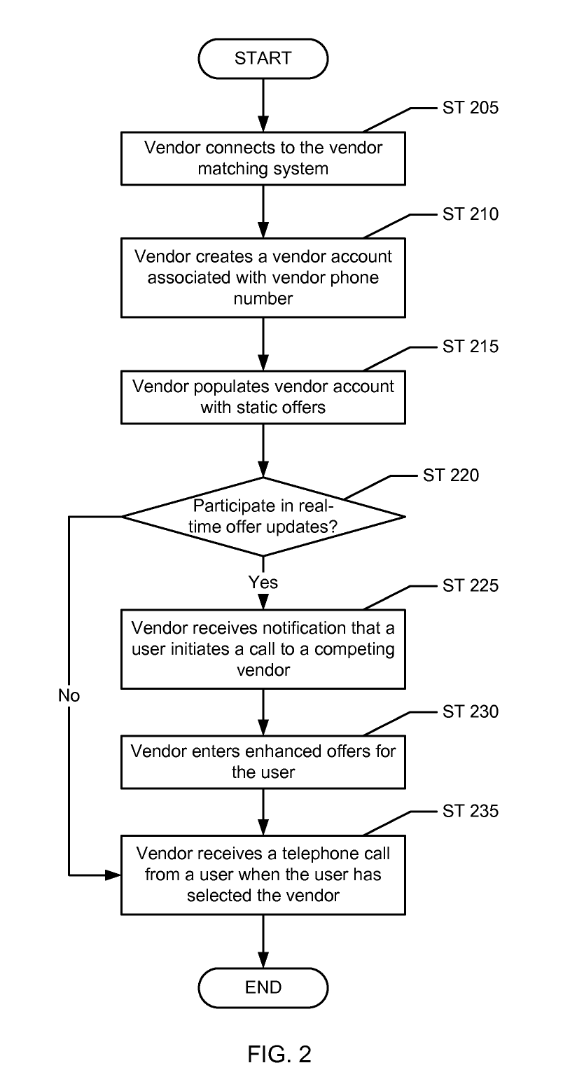

According to one or more embodiments of the invention, the mobile device (110) may communicatively connect to the vendor matching system (105) and the vendor(s) (e.g., Vendor A (115A))-Vendor N (115N)) using the Internet (160). For example, the mobile device (110) may include functionality to connect with other devices over the Internet. Further, according to one or more embodiments of the invention, Vendor A (115A))-Vendor N (115N) may also be configured to connect to other devices over the Internet (160). For example, a vendor (e.g., Vendor A (115A)-Vendor N (115N)) may connect to the vendor matching system (105) in order to provide data stored in the vendor account store (145). This process is described in detail in the description of FIG. 2.

FIG. 2 shows a flowchart in accordance with one or more embodiments of the invention. The process shown in FIG. 2 may be used, for example, by a vendor to set up a vendor account. In one or more embodiments of the invention, one or more of the steps shown in FIG. 2 may be omitted, repeated, and/or performed in a different order than that shown in FIG. 2. Accordingly, the specific arrangement of steps shown in FIG. 2 should not be construed as limiting the scope of the invention.

At ST 205, a vendor connects to (e.g., by logging into or otherwise accessing) the vendor matching system. According to one or more embodiments of the invention, a representative for the vendor may connect to the vendor matching system using the Internet or another network, as described in FIG. 1 above. Further, according to one or more embodiments of the invention, the vendor may simply initiate a connection between the vendor and the vendor matching system.

At ST 210, a vendor account is created to associate the vendor with a vendor phone number. According to one or more embodiments of the invention, the vendor may submit the vendor's telephone number or other identifying information (e.g., mobile device serial number, IP address, etc.) to the vendor matching system to determine that a user is attempting to connect to the vendor when making a telephone call.

According to one or more embodiments of the invention, at ST 210, the vendor may also create the vendor account by submitting data, such as matching data, for the vendor. As described above, the matching data may include, for example, goods or services provided by the vendor. According to one or more embodiments of the invention, a vendor may select matching data from predefined/default matching data provided by the vendor matching system. For example, the vendor matching system may provide a list of services from which the vendor may make a selection. Thus, if, for example, the vendor is an Italian restaurant specializing in pizza, the vendor may select such categories as “pizza” and “Italian food.” In one or more embodiments of the invention, providing predetermined/default categories simplifies the process of identifying suggested vendors for the user. Further, according to one or more embodiments of the invention, determining matching data may be performed automatically (e.g., with limited input by the vendor) by the vendor matching system based on gathered data from the user, the user's device (e.g., location, usage history, downloaded data for various applications, etc.), the vendor, or other sources.

At ST 215, the vendor populates the vendor account with static offers. According to one or more embodiments of the invention, static offers are coupons or other discount and/or promotional offers for the offered service provided by the vendor. More specifically, static offers may be generic offers that are globally provided to users that use the vendor matching system. In one or more embodiments of the invention, the static offers are only valid for a limited time. These static offers are distinguished from enhanced offers, as described below. However, for purposes of this description, static offers and enhanced offers are both referred to collectively as offers.

At ST 220, the vendor determines whether to participate in real-time offer updates. According to one or more embodiments of the invention, a real-time offer update allows a vendor to be notified (in real-time, while the mobile device user is waiting to place an order) when the vendor has been identified as a suggested vendor for a user and prompts the vendor to provide enhanced offers. This process is described in detail with regard to FIG. 4 below. According to one or more embodiments of the invention, enhanced offers are offers that are provided by the vendor in real time.

The process of setting up a vendor account generally ends at ST 220. According to one or more embodiments of the invention, the vendor either waits for a telephone call or other notification that the vendor has been identified as suggested vendor for a user. Specifically at ST 225, according to one or more embodiments of the invention, when a vendor is participating in real-time offer updates, the vendor receives a notification that a user has initiated a call to a competing vendor. For example, according to one or embodiments of the invention, this notification process occurs when a user has initiated a call either to the vendor or to a competing vendor, and the matching system identifies the vendor as a suggested vendor. According to one or more embodiments of the invention, the vendor may receive a message including all offers that have been selected for the user. Further, according to one or more embodiments of the invention, the message may include a list of all competing vendors that are identified by the matching module as suggested vendors. In one or more embodiments of the invention, the level of detail provided to the vendor about the number and types of offers sent to the user as well as information about competing vendors will vary depending on a level of contribution by the vendor, the status of the vendor, the user preferences, etc.

At ST 230, the vendor is prompted to enter an enhanced offer for the user in accordance with one or more embodiments of the invention. Thus, the vendor may provide an enhanced offer for the vendor's services that is competitive against the other vendors that have been selected as suggested vendors. Examples of enhanced offers may include an additional discount, upgraded quality/service level, waived fees, taxes paid, additional quantity of one or more items included for the same cost (i.e. free of charge), etc. In one or more embodiments of the invention, the enhanced offer is only valid for a limited time. In one or more embodiments of the invention, the vendor may store the enhanced offer as unique to the user that initiated the phone call (based on shared user preferences, historical data, etc.), or the vendor may select to store the enhanced offer as a static offer which is provided globally to all future users or particular users that match the same criteria as the current user.

Alternatively, rather than being supplied by the vendor, enhanced offers may be generated based on any combination of parameters. Two possible parameters that may be used are (a) those parameters received from a user or the user device, and (b) real time variables not related to a user or the vendor. These parameters are described in detail with regard to FIG. 4 below. Further, the vendor is able to enter the parameters into the matching system up front in accordance with one or more embodiments of the invention. If one of the parameters is met, the enhanced offer is generated or stored in accordance with one or more embodiments of the invention.

At ST 235, the vendor receives a telephone call from a user when the user has selected a vendor. The telephone call from a user may be received immediately after providing an enhanced offer resulting from participation in the real-time offer updates. Alternatively, the telephone call from a user may be several hours/days/weeks/months from when the vendor places the static and/or enhanced offers. For example, in the case that the vendor has participated in real-time offer updates at ST 220, the user is provided an enhanced offer (e.g., an additional $10 off, free delivery, taxes paid by the vendor, etc.) following the vendor being notified that the user is initiating a telephone call to a competing vendor. As a result of the enhanced offer, the user terminates the call to the competing vendor and later (such as immediately upon terminating the call, the next day, the next week, the next month, etc.) calls the selected vendor in response to the enhanced offer. Further, in the case that the vendor has not selected to participate in real-time offer updates at ST 220, the vendor later (such as immediately upon the static offer being presented to a user, the next day, the next week, the next month, etc.) receives a phone call from a user in response to one of the static offers populated in ST 215. In one or more embodiments of the invention, the offer is time sensitive and only valid for a limited time period. In such case, the call to the selected vendor in response to the offer must me made within the limited time period to remain valid.

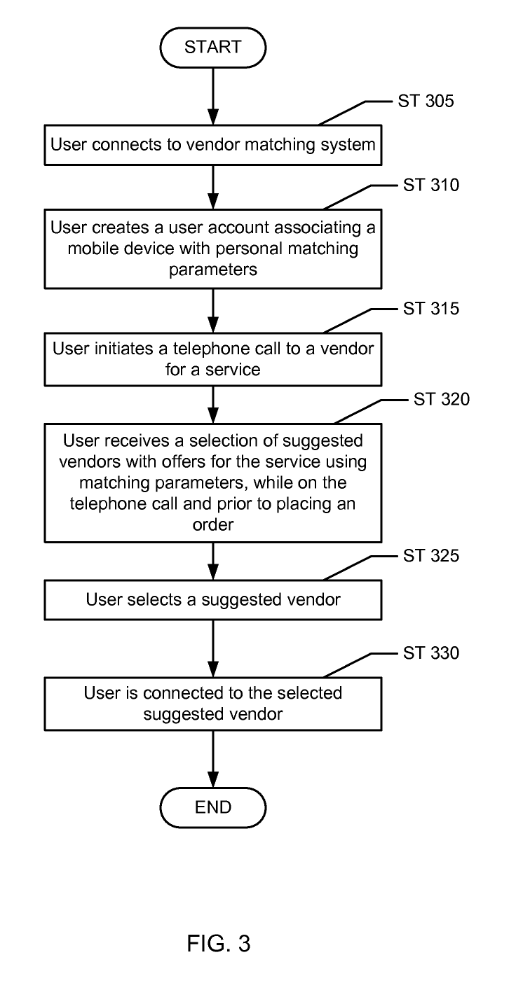

FIG. 3 shows a flowchart in accordance with one or more embodiments of the invention. The process shown in FIG. 3 may be used, for example, by a user in order to set up a user account. In one or more embodiments of the invention, one or more of the steps shown in FIG. 3 may be omitted, repeated, and/or performed in a different order than that shown in FIG. 3. Accordingly, the specific arrangement of steps shown in FIG. 3 should not be construed as limiting the scope of the invention.

At ST 305, the user connects to the vendor matching system. According to one or more embodiments, the user may log into the vendor matching system using a mobile device and a connection over a telecommunications or other network. Alternatively, according to one or more embodiments of the invention, the user may connect to the vendor matching system using a personal computing device configured to connect to the vendor matching system over a network, such as the Internet.

At ST 310, the user creates a user account associating a mobile device with personal matching parameters. For example, the user may create a relationship between the user's account and a telephone number associated with one or more mobile devices such that when the user initiates a telephone call on one of the mobile devices, the vendor matching system may identify the user from the originating telephone number. In one or more embodiments of the invention, the step of creating the user account is only performed once; however, the user is able to connect to the system to modify/update the user account and the personal matching parameters as often or as little as appropriate.

Further, initially or over time, the user may populate the user account with personal matching parameters. The personal matching parameters may be populated through user entry or based on data gathered from user activity, such as activity from the use of a mobile device. According to one or more embodiments of the invention, personal matching parameters may include parameters such as favorite vendors, favorite locations, vendors that should not be included as suggested vendors, or any other matching parameters used to generate a selection of suggested vendors for the user.

At ST 315, a user initiates a telephone call (using a mobile device) to a vendor for a service. For example, using the mobile device, a user may dial a number that is recognized as the telephone number for a specific vendor (found in an online directory, a print or online advertisement, in a paper directory/phone book, etc.).

At ST 320, the user receives a selection of suggested vendors with offers for the service using matching parameters, while on the telephone call and prior to placing an order. According to one or more embodiments of the invention, the selection of suggested vendors may be received on the mobile device via audio, textual, or graphical message. Further, according to one or more embodiments of the invention, the selection of suggested vendors received by the mobile device of the user includes a presentation of the suggested vendors along with the offers provided by the vendors. According to one or more embodiment of the invention, the offers received by the user include static offers and enhanced offers, as described with respect to FIG. 2 above. In one or more embodiments of the invention, ST 225-ST 235 of FIG. 2 occur between ST 315 and ST 320 of FIG. 3.

At ST 325, a user selects a suggested vendor from the selection of suggested vendors. According to one or more embodiments of the invention, the user may use a keyboard or other input device to make the selection. Alternatively, the offer may be selected using only audio selection (with no key/screen-based selection). In other words, the mobile service provide (or other service located on the mobile device or vender matching system) performs a conversion of the audio to data or vice-versa.

At ST 330, the user is connected to the selected suggested vendor. According to one or more embodiments of the invention, the matching system is configured to automatically establish the connection between the mobile phone and the selected suggested vendor. The process of stabling the connection between user and vendor is described in detail with respect to FIG. 4, below.

FIG. 4 shows a flowchart in accordance with one or more embodiments of the invention. The process shown in FIG. 4 may be used, for example, by a matching system or matching module. In one or more embodiments of the invention, one or more of the steps shown in FIG. 4 may be omitted, repeated, and/or performed in a different order than that shown in FIG. 4. Accordingly, the specific arrangement of steps shown in FIG. 4 should not be construed as limiting the scope of the invention.

At ST 402, a notification is received that a mobile device has initiated a call to a telephone number. Specifically, according to one or more embodiments of the invention, a notification is received that a call has been initiated, using the mobile device, to a vendor. According to one or more embodiments of the invention, the notification includes an originating telephone number for the mobile device. Further, according to one or more embodiments of the invention, the notification may include other identifying user data, such as a name, service provider, preferences, etc.

At ST 404, the vendor and matching data for the vendor is extracted based on the telephone number received with the notification. According to one or more embodiments of the invention, the vendor and matching data for the vendor is identified by matching the telephone number in a field of the vendor data store in the matching system. In one or more embodiments of the invention, the vendor and matching data could also be extracted using data made publicly available by the vendor or third parties even if the vendor is not associated with a vendor account or not found in the vendor data store.

At ST 406, suggested vendors, which provide offers for the comparable service, are selected using matching parameters and matching data. For example, the vendor to which the user initiated a call is associated with matching data that helps determine the services provided by the vendor. Matching parameters are then used to identify one or more suggested vendors that provide comparable service. Matching parameters may include, for example, location, offers, services, or any other parameters that may be used to identify suggested vendors. According to one or more embodiments of the invention, suggested vendors may be identified from vendors that have vendor accounts stored with the vendor matching system, or vendors that have made offers publicly available (e.g., on their website or another website advertisement).

At ST 408, a determination is made whether vendors are participating in real-time offer updates. According to one or more embodiments of the invention, this determination is made for each vendor which is identified as a suggested vendor at ST 406. For each vendor who has selected to participate in real-time offer updates, the flow chart continues from ST 410 through ST 414. For those vendors who have not selected to participate in real-time offer updates, the flow chart proceeds directly to ST 416; however, in one or more embodiments of the invention, the non-participating vendor's offers will not be presented to the user until the vendor with enhanced offers are ready to present.

At ST 410, a notification is sent to the suggested vendor(s) who participate in real-time offer updates that a match has occurred. As a result, the suggested vendor(s) are prompted to provide enhanced offers. Said another way, each vendor is made aware that the vendor(s) is selected. According to one or more embodiments of the invention, the notification may also include one or more offers provided by/for one or more of any other suggested vendors, as discussed above.

At ST 412, the matching system receives one or more enhanced offers from the suggested vendor(s) who selected to participate in real-time offer updates. For example, as described above, the enhanced offer(s) may be one or more offers particularized for the user who has initiated the telephone call, or be global in nature. Further, according to one or more embodiments of the invention, the enhanced offer(s) may granular in nature (i.e. the offer(s) may be made available to a particular set of users of the matching system based on a specific criteria). For example, the enhanced offer(s) may be made available to users within a specific geographic area. Another example is the enhanced offer(s) may be made available to users who are new to using the vendor matching system. In these cases, according to one or more embodiments of the invention, the enhanced offer(s) may be determined based on data found within a user account.

As discussed above in relation to FIG. 2, rather than being supplied by the vendor, enhanced offers may be generated based on any combination of parameters. Two possible parameters that may be used are (a) those parameters received from a user or the user device, and (b) real time variables not related to a user or the vendor.

Examples of parameters received from a user may include the location of the user with respect to the vendor (either user entered or acquired from a location aware mobile device) and the weather at location of the user and/or vendor. For example, if a user location is more than 10 miles from the vendor then the enhanced offer is $10 off. Similarly, if it is raining near the vendor or where the user is located then an enhanced offer of an additional 10% is provided. As one skilled in the art will appreciate, multiple such parameters and combinations of these parameters could generate unique real-time offers specific for the user.

Examples parameters that are real-time variables that are not related to a user or vendor include current events and/or changes in laws. For example, if a celebrity is spotted wearing a particular dress and it creates a flood of publicity, the enhanced offer is generated to discount the dress by 5%. Similarly, if the governor increases sales tax on hybrid cars, the dealer may submit an enhanced offer to waive sales tax.

At ST 414, the vendor account(s) for the suggested vendor(s) are updated with the one or more enhanced offers. Said another way, in one or more embodiments of the invention, the one or more enhanced offers are stored in the vendor account store of the vendor matching system in a manner so that the offer(s) may be later presented to the user of the mobile device, as described below.

At ST 416, a user account is identified which is associated with the initiated telephone call. According to one or more embodiments of the invention, the user account may be identified by a telephone number or other identifier registered by the user as being associated with the user.

At ST 418, a determination is made regarding whether the user account includes personal matching parameters, as described above. In the case that the user account includes personal matching parameters, the flow chart continues at ST 420.

At ST 420, the suggested vendor(s) are sorted using the personal matching parameters. According to one or more embodiments of the invention, sorting the vendors may include removing vendors that fall outside the personal matching parameters. Further, in one or more embodiments of the invention, the personal matching parameters may also be used to determine an order of the suggested vendors to present to the user. For example, based on the personal matching parameters, the suggested vendors may be ranked, presented in order of best match first, or another matching algorithm chosen by the user.

Upon completion of ST 420, or in the case that the user account does not include personal matching parameters in ST 418, the flow chart continues at ST 422. At ST 422, offer(s) from the suggested vendor(s) are presented to the user. As described above, the suggested vendor(s) and/or offer(s) may be presented via audio, graphical, or textual message to the user's mobile device. Further, the order and format that the suggested vendor(s) and offer(s) are presented in may be a default setting or in a manner determined using the personal matching parameters.

At ST 424, the vendor(s) selected by the user is identified. According to one or more embodiments of the invention, the user may pick more than one vendor. At ST 426, the initiated telephone call is terminated. According to one or more embodiments of the invention, terminating the initiated call requires disconnecting the call to the dialed telephone number. Further, according to one or more embodiment of the invention, when the initially dialed vendor is also the selected vendor, terminating the telephone call requires terminating the connection to the vendor matching system, or otherwise inactivating the initiated telephone call. Finally, at ST 428, the user on the mobile device is connected to the selected vendor or vendors. For example, the user may be disconnected from a first vendor and then automatically connected to the selected vendor or vendor(s). The manner (and timing) in which the user is connected to the selected vendor(s) may vary greatly, but what is important is that the initial call is terminated, followed by a connection (in some manner over some period of time) by the user of the mobile device to the selected vendor(s) (even if the selected vendor is the same vendor connected for the initial call and the later connection is made an hour later).

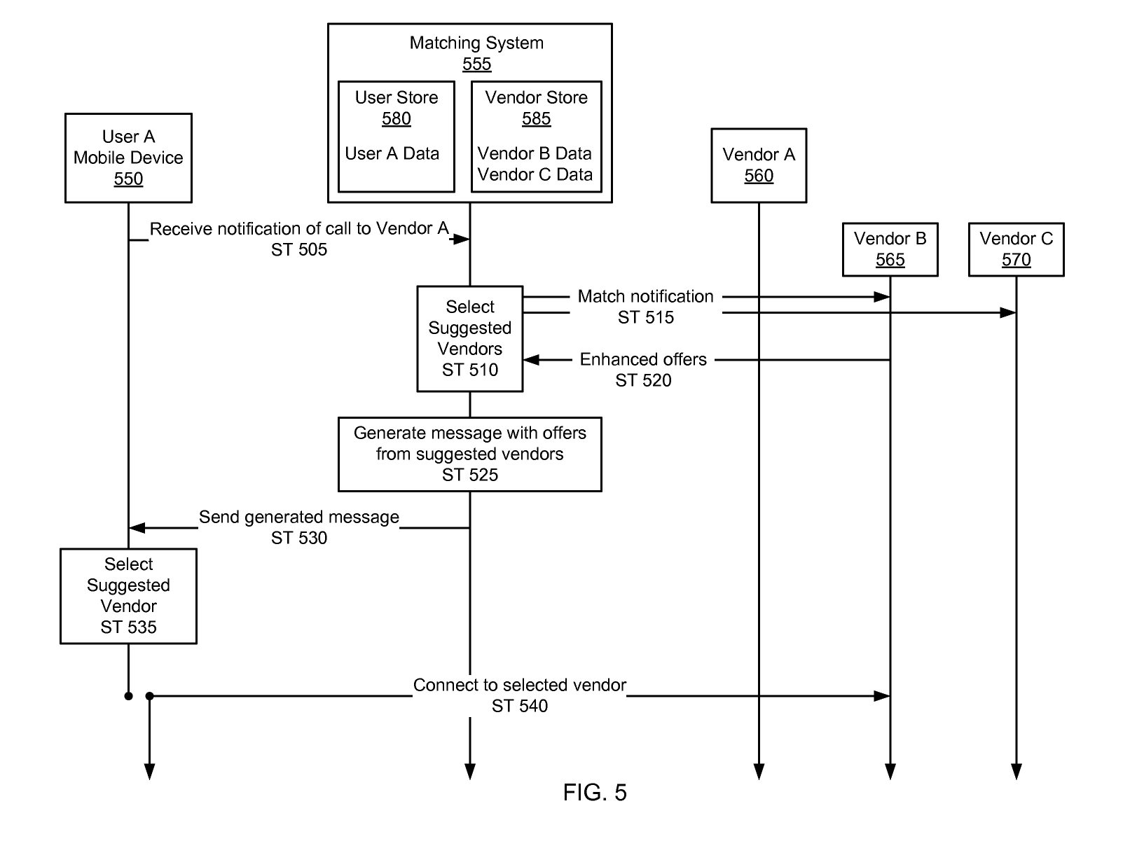

FIG. 5 shows a flow diagram in accordance with one or more embodiments of the invention. Specifically, FIG. 5 shows the flow of data between User A Mobile Device (550), Matching System (555), Vendor A (560), Vendor B (565), and Vendor C (570). As shown, Matching System (555) corresponds to a vendor matching system, as described above. Further, Matching System (555) includes a User Store (580), which, for purposes of this example, is a user account store, as well as a Vendor Store (585), which, for purposes of this example, is a vendor account store. As shown, User Store (580) includes user account information for User A. Further, Vendor Store (585) includes vendor account data for Vendor B and Vendor C. For purposes of this example, the Vendor Store (585) indicates that Vendor B and Vendor C have established vendor accounts with the vendor matching system, while Vendor A does not.

The flow diagram begins at ST 505, where a notification of a call to Vendor A from User A Mobile Device (550) is sent to the Matching System (555). Said another way, User A initiates a telephone call to Vendor A. According to one or more embodiments of the invention, the notification includes the telephone number (or other identifying information) for Vendor A.

At ST 510, the Matching System (555) selects suggested vendors for User A. As described above, according to one or more embodiments of the invention, the Matching System (555) may select suggested vendors using matching data for Vendor A, as well as matching parameters. As shown, Vendor A does not have an established vendor account in the Matching System (555), so match information is not found in the vendor store (585). However, although not shown, the Matching System (555) could obtain matching data from data made publicly available on the Internet or otherwise, regarding Vendor A.

Continuing with ST 510, as part of selecting suggested vendors a match notification is sent to vendors that have selected to participate in real-time offer updates. In this example, Vendor B (565) and Vendor C (570) are both sent a match notification, as shown in ST 515. According to one or more embodiments of the invention, Vendor B (565) and Vendor C (570) each receive a notification including a list of all the vendors that have been identified as a suggested vendor. Further, according to one or more embodiments of the invention, the match notification may indicate that User A is the user who has initiated the telephone call and/or that User A initiated the telephone call to Vendor A.

At ST 520, Vendor B (565) sends an enhanced offer back to the Matching System (555). Vendor B (565) may send an enhanced offer specifically for User A or an offer that is to be made available to any set of users. Based on the knowledge that Vendor A (560) is the intended vendor, Vendor C (570) is another selected vendor, and User A is the user, Vendor B (565) is able to make an enhanced offer knowing the price that Vendor A (560) and Vendor C (570) normally charges or discounts generally given to people in the same locality as User A (based on data about User A found in User Store (580)). In this example, Vendor C (570) fails to send an enhanced offer within the time frame allowed for responding to the match notification received from the Matching System (555), so a static offer is used for Vendor C (570).

At ST 525, Matching System (555) generates a message with suggested vendors, as well as their respective offers (e.g., static offer(s) for Vendor C (570) and enhanced offer(s) for Vendor B (565)). The message may be generated using global matching parameters, as well as personal matching parameters. Further, as described above, in one or more embodiments of the invention, the matching parameters may determine how the message is formatted for the user.

At ST 530, the generated message is sent to the User A Mobile Device (550). In this example, the message includes two enhanced offers from Vendor B (565) and a single static offer from Vendor C (670) in the form of both a text message and an audio message that is sorted with the offer having the greatest percentage discount first.

At ST 535, User A selects at least one suggested vendor based on the offer(s). In this example, User A selects the first listed enhanced offer from Vendor B (565), which provides the greatest percentage discount, by typing the letter next to the offer into the input device of User A Mobile Device (550). Alternatively, the offer may be selected using only audio selection (with no key/screen-based selection). In other words, the mobile service provide (or other service located on the mobile device or vender matching system) performs a conversion of the audio to data or vice-versa.

After ST 535, the telephone call initiated by User A Mobile Device (550) to Vendor A (560) is terminated, and a connection is created to the selected vendor, Vendor B (565), at ST 540. According to one or more embodiments of the invention, terminating the initiated call includes terminating the processes between the User A Mobile Device (550) and the Matching System (555). According to one or more embodiments of the invention, terminating the initiated call includes configuring the User A Mobile Device (550) to be able to create a connection to the selected vendor, Vendor B (565).

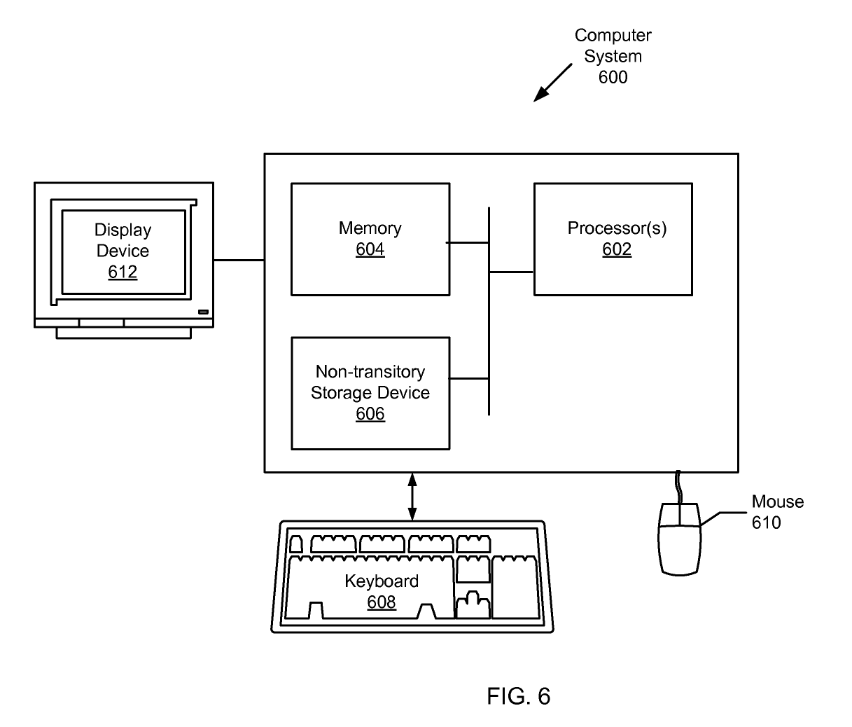

Embodiments of the invention may be implemented on virtually any type of computer regardless of the platform being used. For example, as shown in FIG. 6, a computer system (600) includes one or more processors (602), such as an integrated circuit, central processing unit (CPU), or other hardware processor, associated memory (604) (e.g., random access memory (RAM), cache memory, flash memory, etc.), a non-transitory storage device (606) (e.g., a hard disk, an optical drive such as a compact disk drive or digital video disk (DVD) drive, a flash memory stick, etc.), and numerous other elements and functionalities typical of today's computers (not shown).

The computer system (600) may also include input means, such as a keyboard (608), a mouse (610), or a microphone (not shown). Further, the computer (600) may include output means, such as a monitor (612) (e.g., a liquid crystal display (LCD), a plasma display, or cathode ray tube (CRT) monitor). The computer system (600) may be connected to a network (not shown) (e.g., a local area network (LAN), a wide area network (WAN) such as the Internet, or any other similar type of network) via a network interface connection (not shown). Those skilled in the art will appreciate that many different types of computer systems exist, and the aforementioned input and output means may take other forms. Generally speaking, the computer system (600) includes at least the minimal processing, input, and/or output means necessary to practice embodiments of the invention.

Further, those skilled in the art will appreciate that one or more elements of the aforementioned computer system (600) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a non-transitory computer readable storage medium such as a compact disc (CD), a diskette, a tape, or any other non-transitory computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for presenting a vendor selection to a user of a mobile device, comprising:
receiving a notification that a first telephone call is initiated by the user of the mobile device to a telephone number for a first vendor;
while the first telephone call is active and prior to placing an order with the first vendor:
extracting, using a computer processor, a plurality of matching data for the first vendor using the telephone number for the first vendor,
selecting, using the computer processor, at least one suggested vendor using a plurality of matching parameters and the plurality of matching data, wherein each of the at least one suggested vendor is associated with an offer,
generating a message comprising the first vendor and the at least one suggested vendor with the offer, and
presenting the message to the user of the mobile device;
terminating, prior to placing the order, the first telephone call to the first vendor; and
initiating a second telephone call to the at least one suggested vendor based on the offer.

2. The method of claim 1, wherein prior to presenting the message to the user of the mobile device, the method further comprises:
sending a match notification to the at least one suggested vendor;
receiving an enhanced offer from the at least one suggested vendor; and
incorporating the enhanced offer into the message presented to the user of the mobile device.

3. The method of claim 1, wherein prior to presenting the message to the user of the mobile device, the method further comprises:
generating an enhanced offer based on one or more predefined parameters; and
incorporating the enhanced offer into the message presented to the user of the mobile device.

4. The method of claim 3, wherein the one or more predefined parameters are provided by the user.

5. The method of claim 3, wherein the one or more predefined parameters are one or more real-time parameters not entered by the user or vendor.

6. The method of claim 1, wherein generating the message further comprises:
receiving a plurality of personal matching parameters from the mobile device, and
ranking the at least one suggested vendors using the plurality of personal matching parameters.

7. The method of claim 1, wherein the plurality of matching parameters comprises at least one selected from a group consisting of a vendor service type and a vendor location.

8. The method of claim 1, wherein the plurality of matching data comprises a service type and a location associated with the first vendor.

9. The method of claim 1, wherein the message is an audible message.

10. The method of claim 1, wherein the first telephone call is interrupted by a mobile application on the mobile device to present the message.

11. The method of claim 1, wherein the first telephone call is interrupted by a mobile service provider to present the message.

12. A computer readable storage medium comprising computer readable code that, when executed by a processor, is configured to perform a method comprising:
receiving a notification that a first telephone call is initiated by a user of a mobile device to a telephone number for a first vendor;
while the first telephone call is active and prior to placing an order with the first vendor:
extracting a plurality of matching data for the first vendor using the telephone number for the first vendor,
selecting at least one suggested vendor using a plurality of matching parameters and the plurality of matching data, wherein each of the at least one suggested vendor is associated with an offer,
generating a message comprising the first vendor and the at least one suggested vendor with the offer; and
presenting the message to the user of the mobile device;
terminating, prior to placing the order, the first telephone call to the first vendor; and
initiating a second telephone call to the at least one suggested vendor based on the offer.

13. The computer readable storage medium of claim 12, wherein prior to presenting the message to the user of the mobile device, the method further comprises:
sending a match notification to the at least one suggested vendor;
receiving an enhanced offer from the at least one suggested vendor; and
incorporating the enhanced offer into the message presented to the user of the mobile device.

14. The computer readable storage medium of claim 12, wherein prior to presenting the message to the user of the mobile device, the method further comprises:
generating an enhanced offer based on one or more predefined parameters; and
incorporating the enhanced offer into the message presented to the user of the mobile device.

15. The computer readable storage medium of claim 14, wherein the one or more predefined parameters are provided by the user.

16. The computer readable storage medium of claim 14, wherein the one or more predefined parameters are one or more real-time parameters not entered by the user or vendor.

17. The computer readable storage medium of claim 12, wherein generating the message further comprises:
receiving a plurality of personal matching parameters from the mobile device, and
ranking the at least one suggested vendors using the plurality of personal matching parameters.

18. The computer readable storage medium of claim 12, wherein the plurality of matching parameters comprises at least one selected from a group consisting of a vendor service type and a vendor location.

19. The computer readable storage medium of claim 12, wherein the matching data comprises a service and a location associated with the first vendor.

20. The computer readable storage medium of claim 12, wherein the message is an audible message.

21. The computer readable storage medium of claim 12, wherein the first telephone call is interrupted by a mobile application on the mobile device to present the message.

22. The computer readable storage medium of claim 12, wherein the first telephone call is interrupted by a mobile service provider to present the message.

23. A system for presenting a vendor selection to a user, comprising:
vendor account data store located on a persistent storage device and comprising a plurality of vendors and a plurality of matching data;
a mobile device configured to:
initiate a first telephone call to a first vendor of the plurality of vendors,
receive and present a message to the user of the mobile device,
terminate, prior to placing an order, the first telephone call to the first vendor, and
initiate a second telephone call to at least one suggested vendor based on an offer; and
a matching module executable by a computer processor and configured to:
receive a notification that the first telephone call is initiated by the user of the mobile device to a telephone number for the first vendor,
while the first telephone call is active and prior to placing an order with the first vendor:
extract the plurality of matching data for the first vendor using the telephone number for the first vendor,
select at least one suggested vendor from the plurality of vendors using a plurality of matching parameters and the plurality of matching data, wherein each of the at least one suggested vendor is associated with the offer, and
generate the message comprising the first vendor and the at least one suggested vendor with the offer.

24. The system of claim 23, further comprising a user account store, wherein the user account store comprises the plurality of personal matching parameters.

25. The system of claim 24, wherein, prior to presenting the message to the mobile device, the matching module is further configured to:
receive the plurality of personal matching parameters from the mobile device, and
rank the at least one suggested vendors using the plurality of personal matching parameters.

26. The system of claim 23, wherein, prior to presenting the message to the mobile device, the matching module is further configured to:
generate an enhanced offer based on one or more predefined parameters; and
incorporate the enhanced offer into the message presented to the user of the mobile device.

27. The system of claim 26, wherein the one or more predefined parameters are provided by the user.

28. The system of claim 26, wherein the one or more predefined parameters are one or more real-time parameters not entered by the user or vendor.

29. The system of claim 23, wherein the matching module, prior to presenting the message to the user of the mobile device, is further configured to:
send a match notification to the at least one suggested vendor;
receive an enhanced offer from the at least one suggested vendor; and
incorporate the enhanced offer into the offer associated with the at least one suggested vendor.

30. The system of claim 23, wherein the mobile device comprises a mobile application configured to interrupt the first telephone call to present the message.

31. A method for presenting a vendor selection to a user, comprising:
determining, using a computer processor, that a first telephone call to a first vendor has been initiated on a mobile device, wherein a user of the mobile device has initiated the first telephone call using a telephone number for the first vendor;
while the first telephone call is active and prior to placing an order with the first vendor, sending a request for suggested vendors to a matching system, wherein the matching system is configured to:
extract a plurality of matching data for the first vendor using the telephone number for the first vendor,
selecting the at least one suggested vendor using a plurality of matching parameters and the plurality of matching data, wherein each of the at least one suggested vendor is associated with an offer,
generating a message comprising the first vendor and the at least one suggested vendor with the offer, and
presenting the message to the user of the mobile device;
terminating, prior to placing the order, the first telephone call to the first vendor; and
initiating a second telephone call to the at least one suggested vendor based on the offer.

32. The method of claim 31, wherein prior to presenting the message to the user of the mobile device, the method further comprises:
sending a match notification to the at least one suggested vendor;
receiving an enhanced offer from the at least one suggested vendor; and
incorporating the enhanced offer into the offer associated with the at least one suggested vendor.

33. The method of claim 31, wherein prior to presenting the message to the user of the mobile device, the method further comprises:
generating an enhanced offer based on one or more predefined parameters; and
incorporating the enhanced offer into the offer associated with the at least one suggested vendor.

34. The method of claim 33, wherein the one or more predefined parameters are provided by the user.

35. The method of claim 33, wherein the one or more predefined parameters are one or more real-time parameters not entered by the user or vendor.

36. The method of claim 31, wherein generating the message comprises:
identifying a plurality of personal matching parameters for the user, and
ranking the vendor selection using the plurality of personal matching parameters.

37. The method of claim 31, wherein the matching data comprises a service and a location associated with the first vendor.

38. The method of claim 31, wherein the plurality of matching parameters comprises at least one selected from a group consisting of a vendor service and a vendor location.

39. The method of claim 31, wherein the message is an audible message.
